(19) United States
(12) Patent Application Publication
(10) Pub. No.: US 2014/0190446 A1
(43) Pub. Date: Jul. 10, 2014

(54) FIXED VANE ROTARY ABUTMENT ENGINE

(71) Applicant: T. Towles Lawson, JR., Charlottesville, VA (US)

(72) Inventor: T. Towles Lawson, JR., Charlottesville, VA (US)

(21) Appl. No.: 14/152,163

(22) Filed: Jan. 10, 2014

Related U.S. Application Data
(60) Provisional application No. 61/751,129, filed on Jan. 10, 2013.

(51) Int. Cl. F02B 53/02

(52) U.S. Cl. CPC F02B 53/02
USPC 123/200

(57) ABSTRACT

A single stroke engine fixed vane rotary abutment engine is provided in which all for phases of combustion are completed during one revolution of a main rotor. Intake and exhaust ducts are timed to be open or closed depending on which of the intake, compression, power and exhaust events is occurring. At least one abutment rotor cooperates with the main rotor having vanes thereon to define a combustion chamber and uncover ports in the stator of the engine to allow air and fuel to enter the combustion chamber and to all exhaust to exit the chamber.

This application claims the benefit of U.S. provisional patent application No. 61/751,129 filed Jan. 10, 2013.

### BACKGROUND OF THE INVENTION

Otto and diesel engines rely on either two or four strokes of a piston in a cylinder in order to perform all four phases of a near constant volume combustion. These four phases include intake, compression, expansion and exhaust and they all occur within the cylinder. Two stroke engines have ample power density because there is one power or expansion stroke per crankshaft revolution. Compression and exhaust phases occur simultaneously in a two stroke engine as a fresh air/fuel mixture is forced into the combustion chamber and the exhaust from the previous expansion stroke is displaced from the combustion chamber. A four stroke engine devotes one half of each crankshaft revolution to each phase of the cycle. The four stroke engine has positive scavenging of exhaust.

Gas turbines work in a constant pressure and constant combustion system commonly referred to as a Brayton cycle engine. Originally, George Brayton's Ready Motor included pistons within cylinders, but combustion took place in a separate combustor. While all four phases of a gas turbine occur continuously, each phase happens in a different component of the engine. The parts of a Brayton cycle engine include a compressor, a combustor, and an expander. The expander in a gas turbine is the turbine.

Hybrids of gas turbines and constant volume combustion systems also exist. A turbocharged reciprocating engine can be considered as a gas turbine, the combustor for which is a positive displacement pump designed to provide shaft power when fuel is burned within the combustor.

The positive displacement pump geometries which have historically lent themselves to Otto and diesel engines are pistons in cylinders and positive displacement reciprocating engines, such as a Wankel engine. Oil is used to lubricate the parts which slide across each other in these engines. The Wankel engine is a constant volume combustion, positive displacement reciprocating engine similar to a piston engine but unlike a Brayton engine. A Wankel engine and a piston engine technically are not constant volume engines, but their volume increases during the expansion stroke at a rate which is very much slower than the exploding gases increase in the combustion chamber.

### BRIEF DESCRIPTION OF THE PRIOR ART

Some attempts are underway to produce constant volume combustors for gas turbines which consume rather than produce shaft power as evidenced by U.S. Pat. Nos. 5,197,276 and 8,117,828 and U.S. patent application Ser. No. 13/308,506. The resulting engines are referred to as pulse detonation engines. Buzz bombs were simple versions of pulse detonation engines but without a gas turbine assembly. Brayton cycle gas turbines which have pulse detonation combustors in place of or in addition to a traditional combustor are examples of more recent pulse detonation engines. Gas turbines with pulse detonation combustors are exemplified by Humpheys cycle engines.

The original Lenoir engine had a double acting piston as was common in steam engines. Within the half of the Lenoir engine above the piston, the four processes of intake, compression, combustion, and exhaust are as follows. Starting at top dead center, the intake valve is open as the piston begins its downward stroke which draws in fresh air and fuel. Part way through the intake stroke, the intake valve closes (with the exhaust valve remaining closed) and the ignition spark occurs. The second part of the downward stroke is the power stroke. The compression stroke as a separate process is eliminated. At about bottom dead center, the exhaust valve opens, and the piston moves back toward top dead center, positively scavenging the burned gas on the way.

The advantages and disadvantages of the Lenoir configuration relative to modern two and four stroke spark ignition engines are as follows. The lack of a compression stroke results in poor power density, and arguably poor, efficiency, in the Lenoir configuration relative to modern reciprocating engines which decrease the volume of the fuel and air mixture before igniting the mixture. The fact that the Lenoir engine positively scavenges the exhaust is a potential advantage over two stroke engines from the perspectives of both emission and fuel consumption, because no intake charge communicates with an open exhaust port.

Atkinson and Miller cycle four stroke engines offer improved fuel efficiency relative to their naturally aspirated and supercharged counterparts by delaying the closing of the intake valve until well into the compression stroke. These engines thus represent an overlap between the intake and compression phases. Atkinson cycle engines such as those in a Toyota Prius have good efficiency but low power density. Miller cycle engines such as those in a Mazda Millenium have good efficiency and power density but with the added cost and complexity of a supercharger. All two stroke engines since Dugald Clerk's engine with a separate piston pump and Day's engine having a sealed crankcase connected to the carburetor by a check valve and intake port when uncovered by the piston are technically supercharged. The underside of the piston is the mechanism by which the crank case is pressurized in Day's engine. Uncovering of the intake port by the downward motion of the piston allows the pressurized mixture into the combustion chamber. Many two stroke diesels have separate superchargers like Roots blowers or screw compressors which are different pump geometries from pistons in cylinders.

The present invention was developed in order to overcome the drawbacks of the engines by providing a single stroke rotary abutment engine rather than a piston and cylinder or a Wankel engine.

### SUMMARY OF THE INVENTION

Accordingly, it is a primary object of the invention to provide a fixed vane rotary abutment engine including a stator, a main rotor and at least one abutment rotor. The stator contains a main cylindrical chamber and a second cylindrical chamber communicating with the main chamber. The main and second chambers have parallel spaced longitudinal axes. A main rotor is coaxially arranged in the main chamber and has an outer diameter less than the diameter of the main chamber to define an annular portion of the main chamber. The main rotor includes a vane which extends from an outer surface of the rotor to a location adjacent to the inner surface of the main chamber. An abutment rotor is coaxially arranged in the second chamber and has an outer diameter corresponding with the diameter of the second chamber. The abutment rotor contains a recess in its outer surface which extends parallel to the longitudinal axis of the abutment rotor. The axis of the abutment rotor is spaced from the axis of the main rotor by a distance corresponding with the sum of the radii of the main and abutment rotors. A combustion chamber is defined in the portion of the annular chamber between the vane and the area where the surfaces of the main and abutment rotors are adjacent, there being a small gap between the rotors to allow free rotation thereof about their respective axes. A drive mechanism is connected with the main and abutment rotors to rotate them in opposite directions about their respective axes with the abutment motor recess receiving the main rotor vane once during each revolution of the rotors.

According to a preferred embodiment of the invention, the stator contains a third cylindrical chamber communicating with the main chamber and having a third longitudinal axis parallel to and spaced from the first longitudinal axis. A second abutment rotor is coaxially arranged in the third cylindrical chamber and contains a recess in an outer surface which extends parallel to the third longitudinal axis. The third longitudinal axis is spaced from the first longitudinal axis by a distance corresponding with the sum of the radii of the main and second abutment rotors. The main rotor includes a second vane extending radially outwardly from its outer surface to a location adjacent to the inner surface of the main chamber. A second combustion chamber is defined in a second portion of the annular chamber between the second vane and an area where the outer surfaces of the main and second abutment rotors are adjacent. The rotating mechanism rotates the second abutment rotor about its axis in the same direction of rotation as said first abutment rotor. The first and second rotors make two revolutions for each revolution of said main rotor so that the recesses of the first and second abutment rotors alternately receive the first and second vanes of the main rotor for each revolution of the main rotor.

The third chamber is preferably arranged in the stator diametrically opposite the second chamber and has the same diameter as the second chamber.

Each combustion chamber has an air intake duct, a fuel intake duct, and an igniter arranged in the stator. An exhaust duct is arranged in the stator on the opposite side of each abutment rotor to allow combustion gases to be scavenged from the annular chamber by the vanes on the main rotor.

### BRIEF DESCRIPTION OF THE FIGURES

Other objects and advantages of the invention will become apparent from a study of the following specification when viewed in the light of the accompanying drawing, in which:

FIG. 1 is a sectional view of a fixed vane rotary abutment engine at the beginning of a power stroke according to a preferred embodiment of the invention;

FIG. 2 is a sectional view of the engine of FIG. 1 at the end of a power stroke;

FIG. 3 is a sectional view of the engine of FIG. 1 at its top dead center position;

FIG. 4 is a sectional view of the engine of FIG. 1 at the end of an intake stroke; and

FIG. 5 is a sectional view of an alternate embodiment of the invention at the beginning of a power stroke.

### DETAILED DESCRIPTION

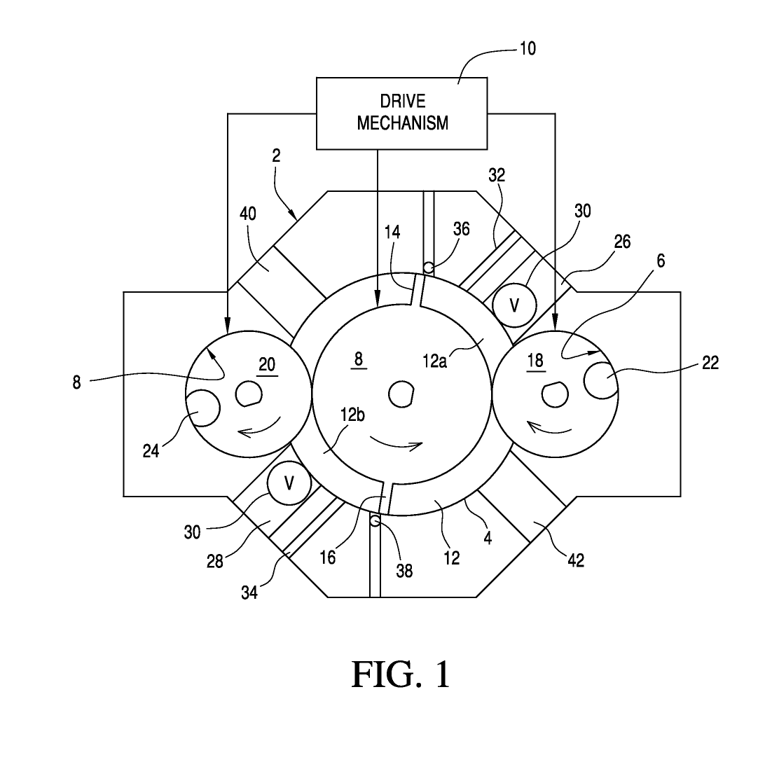

The fixed vane rotary abutment engine according to a preferred embodiment will be described with reference to FIGS. 1-4. The engine includes a stator 2 containing a main cylindrical chamber 4, a first abutment chamber 6, and a second abutment chamber 8. The abutment chambers communicate with the main chamber and are preferably arranged on diametrically opposite sides of the main chamber. Each chamber has a longitudinal axis, with the axes of the abutment chambers 6, 8 being arranged parallel to and spaced from the axis of the main chamber. The spacing between the axes is also preferably the same.

The main chamber 4 contains a main rotor which is rotatable within the chamber. The main rotor is connected with a drive mechanism 10 as will be developed in greater detail below. The outer diameter of the main rotor is less than the diameter of the main chamber so that an annular portion 12 of the main chamber is defined between the stator and the main rotor. The main chamber further includes a vane 14 extending radially outwardly from the outer surface thereof to a location adjacent to the inner wall surface of the main chamber. There is sufficient spacing between the edge of the vane and the inner wall surface of the main chamber to allow the main rotor to rotate freely within the main chamber. The vane extends the length of the main rotor. Preferably, a second vane 16 is also provided extending radially from the rotor diametrically opposite the first vane 14.

A first abutment rotor 18 is arranged within the first abutment chamber 6 and a second abutment rotor 20 is arranged within the second abutment chamber 8. The abutment rotors have an outer diameter corresponding with the diameter of the respective abutment chambers, but a small space is provided between the rotor surfaces and the respective chamber wall surfaces so that the rotors rotate freely within the respective chambers. The abutment rotors are also connected with the drive mechanism. As will be developed in greater detail below, the main rotor rotates in a first direction as shown by the arrow and the abutment rotors rotate in a second direction as shown by the arrows, the second direction being opposite that of the first direction so that the abutment rotors both counter-rotate with respect to the main rotor.

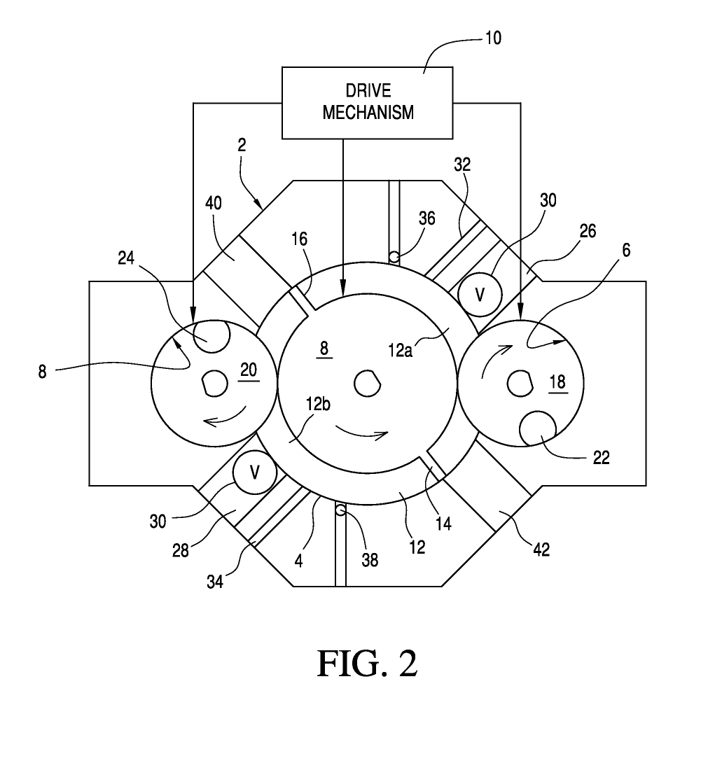

A recess 22 is provided in the outer wall of the first abutment rotor 16 and a similar recess 24 is provided in the outer wall of the second abutment rotor 18. The recesses extend the length of the rotors parallel to the rotor axes, respectively. In order to reduce the abutment rotor speed, more than one recess may be provided in the abutment rotors. The distance between the longitudinal axes of the abutment chambers and the longitudinal axis of the main chamber corresponds to the sum of the radii of the main rotor and of the abutment rotors. Thus, each abutment rotor surface meets a surface of the main rotor. The surfaces do not touch so that all rotors rotate freely. However, the spacing between the rotor surfaces is maintained as small as possible. Thus, as the rotors rotate, the recesses 22, 24 of the abutment rotors 6, 8 receive the vanes 14, 16 of the main rotor as shown in FIG. 2.

In the preferred embodiment shown in FIGS. 1-4, two combustion chambers are defined within the annular chamber 12 of the engine. One combustion chamber 12a is defined in the portion of the annular chamber between the area where the main rotor 8 meets the first abutment motor 18 and the vane 14. The other combustion chamber 12b is defined between the area where the main rotor 8 meets the second abutment rotor 20 and the vane 16.

In order to create combustion within the combustion chambers, the stator includes two air intake ducts. The air intake duct 26 communicates with the combustion chamber 12a and the air intake duct 28 communicates with the combustion chamber 12b. Each air intake duct contains a valve 30 to control the delivery of air to the respective combustion chambers. The stator also includes two fuel injector ports. The fuel injector port 32 communicates with the combustion chamber 12a and the fuel injector port 34 communicates with the combustion chamber 12b to deliver fuel to the respective combustion chambers. The stator includes two igniters such as spark plugs. The igniter 36 ignites the fuel air mixture in the combustion chamber 12a and the igniter 38 ignites the fuel air mixture in the combustion chamber 12b. As shown in FIGS. 1-4, the igniters are arranged downstream of the fuel injector ports which are arranged downstream of the air intake ducts. Lastly, the stator contains two exhaust ducts. The exhaust duct 40 is arranged downstream of the combustion chamber 12a and the exhaust duct 42 is arranged downstream of the combustion chamber 12b relative to the direction of rotation of the main rotor 8. The exhaust duct 40 is arranged on the opposite side of the abutment rotor 20 with respect to the air intake duct 28 and the exhaust duct 42 is arranged on the opposite side of the abutment rotor 18 from the air intake duct 26.

According to a preferred embodiment, the diameters of the abutment rotors 18, 20 are equal and less than the diameter of the main rotor 8. The diameters are selected so that each abutment rotor makes two revolutions for each revolution of the main rotor 8. Thus, for each revolution of the main rotor, combustion occurs twice simultaneously in the combustion chambers 12a, 12b as will be explained below.

FIG. 1 shows the engine at the beginning of its power stroke. At this point, fuel has been introduced into the combustion chambers, and the vanes have moved past the igniters. Residual combustion gas residing in the crevice around the igniter can act as a flame torch. As the mixture ignites it detonates inside the combustion chambers defined by the stator 2, the rotors 8, 18, 20 and the air intake valves 30 which are closed. The vanes 14, 16 are forced counterclockwise by the explosions. Since the vanes are integral to the main rotor, it rotates. The abutment rotors are timing geared to the main rotor via the drive mechanism.

FIG. 2 shows the engine at the end of its power stroke. The air/fuel mixture has combusted and work has been extracted. Most of the combustion gases from the previous cycle have been forced out of the exhaust ducts which the vanes are about to uncover so that the gases of the current cycle can be positively evacuated.

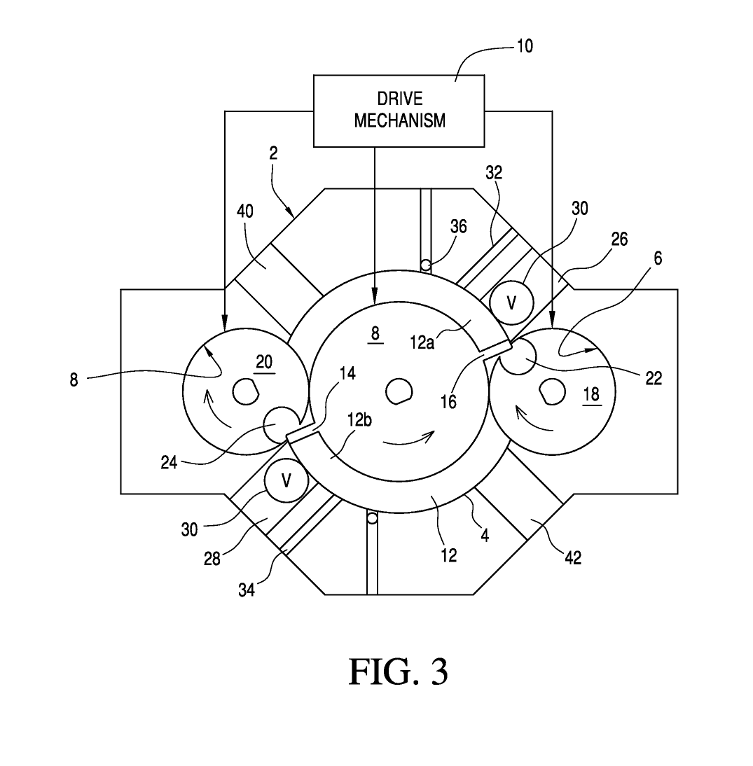

FIG. 3 shows the engine at top dead center. The exhaust ducts 40, 42 are open. The air intake ducts 26, 28 are closed by the valves 30. The valves may be poppet valves driven by a cam or other actuator or check valves. Where timed fuel delivery is directly injected into the combustion chambers, the air intake pressure is higher than the exhaust back pressure and combustion chamber pressure, so the intake duct may be open. This is not strictly necessary because the exhaust gases are positively scavenged by the leading edge of the vanes 14, 16. With carburetor or external fuel injection, the valves in the air intake ducts should are closed so that no unburned fuel can communicate with the exhaust ducts.

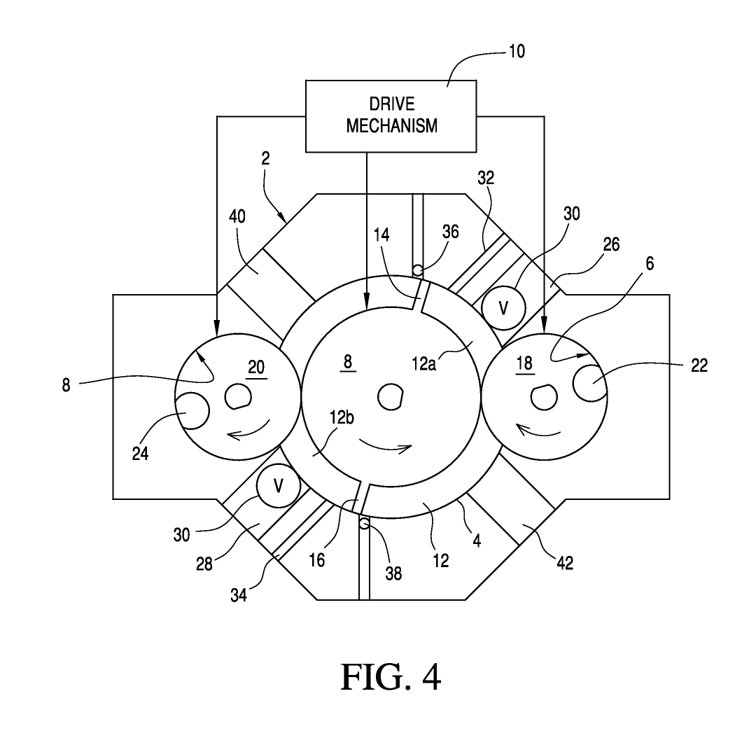

FIG. 4 shows the engine at the end of its intake phase. The vanes 14, 16 have swept counterclockwise past the intake ducts, and the intake charges have entered. The intake charges have fuel mixed therein. The intake charges may be forced or naturally aspirated. The exhaust ducts are open and the leading edge of the vanes force the combustion gases out of the combustion chamber. The engine is once again about to enter the power stroke depicted in FIG. 1.

In an alternate embodiment with few moving parts or controls, fuel and air are mixed externally using a carburetor for example and the mixture is introduced to the combustion chamber through a check valve in an intake duct. An electric resistance igniter is flush with the chamber wall and stays hot enough to ignite the mixture as a vane passes it as shown in FIG. 1.

A more heavily controlled embodiment has the intake positively opened and closed by a camshaft and a spring assembly which are timed to the drive system 10 or by some other timing mechanism for opening intake valves as is known in the art. The direct fuel injection can be timed or can be a constant feed. The igniter is a timed spark and fires at about the time represented in the drawing. There are many examples of wasted spark known to those skilled in the art, and the timing may be electronic or mechanical. If a traditional spark plug is used, the spark plug tip is recessed in the stator wall so that it does not interfere with the rotating vanes of the main rotor. The recess for the spark plug tip acts as a flame holder which then ignites the next intake charge mixture. The spark plug is thus only used for starting and can be turned off once the engine is warm because the ignition time would be a natural consequence of vane position. The fuel injector can also be combined with the igniter recess flame holder such as in the pre-chamber of an indirect injection diesel. The igniter may also be a heater which super heats the fuel just before being introduced to the combustion chambers so that the fuel ignites on contact with the intake charge.

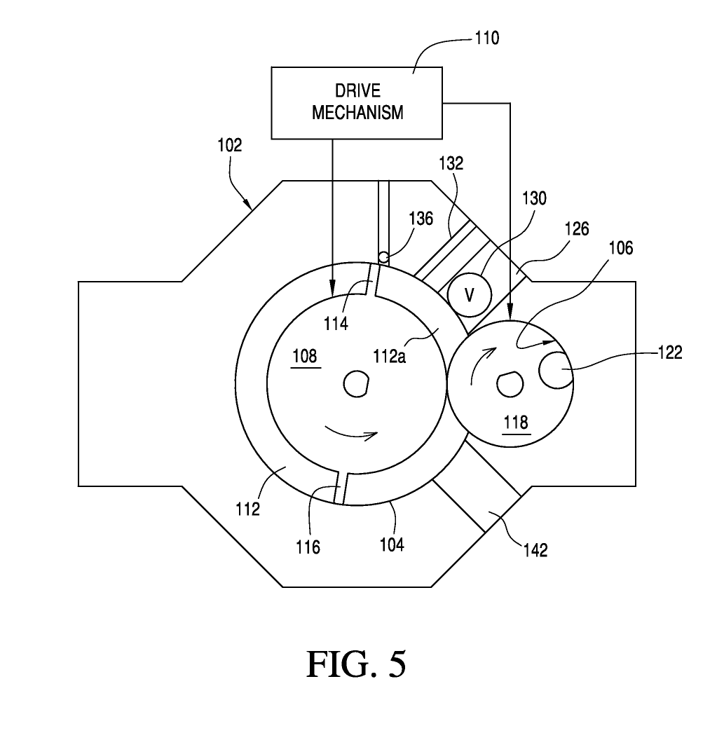

Referring now to FIG. 5, there is shown a simplified version of the fixed vane rotary abutment engine. In this embodiment, the stator 102 includes a main chamber 104 containing a main rotor 108 having vanes 114 and 116. However the stator includes only one abutment chamber 106 containing an abutment rotor 118. With only one abutment rotor, only one combustion chamber 112 is defined within the annular chamber between the main rotor 108 and the wall of the main chamber. Air intake 126 and exhaust 142 ducts are provided in the stator, as are a fuel injection port 132 and an igniter 136. A valve 130 is provided in the intake duct 126. A drive mechanism 110 is connected between the main and abutment rotors which are arranged and sized in the same manner as described above with respect to FIGS. 1-4

The embodiment shown in FIG. 5 operates in a similar manner to the embodiment shown in FIGS. 1-4, except that less power output is provided per revolution of the main rotor. In this embodiment, the combustion is completely isolated for a brief period which makes is suitable for use in a Humphreys cycle engine.

In both embodiments of the invention, an expansion chamber in the exhaust ducts such as is used in two stroke Otto engines can be provided.

While the preferred forms and embodiments of the invention have been illustrated and described, it will be apparent to those of ordinary skill in the art that various changes and modifications may be made without deviating from the inventive concepts set forth above.

What is claimed is:

1. A fixed vane rotary abutment engine, comprising
(a) a stator containing a main cylindrical chamber having a first longitudinal axis and at least one second cylindrical chamber communicating with said main chamber and having a second longitudinal axis spaced from and parallel with said first longitudinal axis;
(b) a main rotor coaxially arranged within said main chamber, said main rotor having an outer diameter less than a diameter of said main chamber to define an annular portion of said main chamber, said main rotor including a vane extending radially outwardly from an outer surface thereof to a location adjacent to an inner surface of said main chamber;
(c) at least one abutment rotor coaxially arranged within said second chamber, said one abutment rotor having an outer diameter corresponding with a diameter of said second chamber, said one abutment rotor containing a recess in an outer surface thereof which extends parallel to said second longitudinal axis, said second longitudinal axis being spaced from said first longitudinal axis by a distance corresponding with the sum of the radii of said main and one abutment rotors, whereby a first combustion chamber is defined in a portion of said annular chamber between said vane and an area where outer surfaces of said main and one abutment rotors are adjacent; and
(d) a mechanism for rotating said main and one abutment rotors in opposite directions within said main and second chambers, respectively, said one abutment rotor recess receiving said main rotor vane during each revolution of said main rotor.

2. A fixed vane rotary abutment engine as defined in claim 1, wherein said stator includes air intake and exhaust ducts communicating with said main chamber, said air intake duct being arranged in said first combustion chamber and said exhaust duct being arranged downstream of said one abutment rotor relative to a direction of rotation of said main rotor.

3. A fixed vane rotary abutment engine as defined in claim 2, wherein said stator further contains a fuel injector port communicating with said first combustion chamber downstream of said air intake duct relative to said direction of rotation of said main rotor.

4. A fixed vane rotary abutment engine as defined in claim 2, wherein said stator includes an igniter arranged in said first combustion chamber downstream of said air intake duct for igniting a mixture of fuel and air in said first combustion chamber.

5. A fixed vane rotary abutment engine as defined in claim 4, and further comprising a valve arranged in said air intake duct to control the delivery of air to said first combustion chamber.

6. A fixed vane rotary abutment engine as defined in claim 1, wherein said main rotor includes a second vane extending radially outwardly from said outer surface thereof to a location adjacent to an inner surface of said main chamber, and further wherein said stator contains a third cylindrical chamber communicating with said main chamber and having a third longitudinal axis spaced from and parallel with said first longitudinal axis, and further comprising a second abutment rotor coaxially arranged within said third chamber, said second abutment rotor containing a recess in an outer surface thereof which extends parallel to said third longitudinal axis, said third longitudinal axis being spaced from said first longitudinal axis by a distance corresponding with the sum of the radii of said main and second abutment rotors, whereby a second combustion chamber is defined in a second portion of said annular chamber between said second vane and an area where outer surfaces of main and second abutment rotors are adjacent, said mechanism rotating said second abutment rotor within said third chamber in the same direction as said one abutment rotor.

7. A fixed vane rotary abutment engine as defined in claim 6, wherein said third chamber is arranged in said stator diametrically opposite said second chamber.

8. A fixed vane rotary abutment engine as defined in claim 7, wherein said second and third chambers have equal diameters and said abutment rotors have equal diameters.

9. A fixed vane rotary abutment engine as defined in claim 8, wherein the diameter of said abutment rotors is less than the diameter of said main rotor.

10. A fixed vane rotary abutment engine as defined in claim 9, wherein said drive mechanism rotates said abutment rotors through two revolutions for each revolution of said main rotor, the recesses of said one and second abutment rotors alternately receiving said vanes of said main rotor for each revolution of said main rotor.

11. A fixed vane rotary abutment engine as defined in claim 10, wherein said stator includes additional air intake and exhaust ducts communicating with said main chamber, said additional air intake duct being arranged in said second combustion chamber and said exhaust duct being arranged downstream of said second abutment rotor relative to a direction of rotation of said main rotor.

12. A fixed vane rotary abutment engine as defined in claim 11, wherein said stator further contains an additional fuel injector port communicating with said second combustion chamber downstream of said additional air intake duct relative to said direction of rotation of said main rotor.

13. A fixed vane rotary abutment engine as defined in claim 12, wherein said stator further includes an additional igniter arranged in said second combustion chamber downstream of said additional fuel injector port for igniting a mixture of fuel and air in said second combustion chamber.

14. A fixed vane rotary abutment engine as defined in claim 13, and further comprising a valve arranged in said air intake ducts to control the delivery of air to said first and second combustion chambers.
